(19) United States
(12) Patent Application Publication
(10) Pub. No.: US 2026/0265521 A1
(43) Pub. Date: Sep. 10, 2026

(54) Low-Swell Foam Composition

(71) Applicant: Porex Corporation, Fairburn, GA (US)

(72) Inventors: Chandrasiri Jayakody, Fairburn, GA (US); Ben Thornton, Fairburn, GA (US)

(21) Appl. No.: 19/073,243

(22) Filed: Mar. 7, 2025

(51) Int. Cl. C08L 75/04; C08K 3/34; C08K 7/28

(52) U.S. Cl. CPC C08L 75/04; C08K 3/34; C08K 7/28; C08K 2003/343; C08L 2201/50; C08L 2203/14; C08L 2205/16

(57) ABSTRACT

Provided herein is a low-swell foam comprising a prepolymer component and an aqueous component comprising water and a polyacrylonitrile fiber, wherein the polyacrylonitrile fiber comprises 0.10% to 1.00% of the aqueous component by weight, and the prepolymer component and the aqueous component are mixed together, and excess water is removed, to form the low-swell foam.

### BACKGROUND

The present disclosure relates to a modified formula for making a low-swell foam which uses fillers or additives to enhance certain features of the low-swell foam.

### BRIEF SUMMARY

Provided herein is a low-swell foam comprising a prepolymer component and an aqueous component comprising water and a polyacrylonitrile fiber, wherein the polyacrylonitrile fiber comprises 0.10% to 1.00% of the aqueous component by weight, and the prepolymer component and the aqueous component are mixed together, and excess water is removed, to form the low-swell foam.

In some embodiments, the prepolymer component and the aqueous component react together at a ratio of 0.70 to 3.00. In some embodiments, the prepolymer component and the aqueous component react together at a ratio of 1.20 to 2.00.

In some embodiments, the prepolymer component is a product of isocyanate and polyols. In some embodiments, the isocyanate is a poly-isocyanate. In some embodiments, the isocyanate comprises 0.5% to 3.5% of the low-swell foam.

In some embodiments, the polyacrylonitrile fiber is acrylic flock.

In some embodiments, the low-swell foam comprises at least one additive. In some embodiments, the at least one additive is an antibacterial and/or an antimicrobial. In some embodiments, the additive is a surfactant, a sealant, a binder, a self-emulsifying base, a colorant, or a salt.

In some embodiments, the low-swell foam comprises a plurality of fillers, wherein each filler of the plurality of fillers comprises about 5% to 50% of the aqueous component by weight. In some embodiments, the low-swell foam comprises a plurality of fillers, wherein the combined weight of the plurality of fillers and the polyacrylonitrile fiber comprise 5.2% to 50% of the aqueous component by weight. In some embodiments, a filler of the plurality of fillers is calcium metasilicate mineral (wollastonite). In some embodiments, the polyacrylonitrile fiber comprises 0.20% to 0.75% of the aqueous component by weight. In some embodiments, the polyacrylonitrile fiber comprises 0.20% to 0.50% of the aqueous component by weight. In some embodiments, the calcium metasilicate material comprises 10% to 45% of the aqueous component by weight. In some embodiments, the calcium metasilicate material comprises 30% of the aqueous component by weight.

In some embodiments, a filler of the plurality of fillers is a plurality of glass spheres. In some embodiments, the plurality of glass spheres comprises up 0.50% to 1.50% of the aqueous component by weight. In some embodiments, the plurality of glass spheres comprises 1.00% of the aqueous component by weight. In some embodiments, the plurality of glass spheres is a plurality of hollow glass spheres with a density of 0.115 g/cc to 0.135 g/cc. In some embodiments, the plurality of hollow glass spheres has a density of 1.125 g/cc. In some embodiments, the plurality of hollow glass spheres has a tensity of 0.45 to 0.50 g/cc. In some embodiments, the plurality of hollow glass spheres has a density of 0.48 g/cc.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows a low-swell foam manufacture according to one embodiment of the invention.

FIG. 2 shows a flowchart depicting one embodiment of a method for providing the low-swell foam manufacture shown in FIG. 1.

### DETAILED DESCRIPTION

The present disclosure relates to a modified formula for making a low-swell foam which uses a prepolymer component and an aqueous component comprising water and a polyacrylonitrile fiber and optionally additives to enhance certain features of the low-swell foam.

Before the present disclosure is described in detail, it is to be understood that the terminology used herein is for purposes of describing particular examples and embodiments only and is not intended to be limiting.

In this detailed description and in the claims that follow, reference will be made to a number of terms that shall be defined to have the following meanings:

As used herein, the terms “optional” or “optionally” mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

In many embodiments below, the present disclosure refers to a foam material. In certain embodiments, the foam is shaped into a sponge shaped for makeup application. While the disclosure may focus on foam sponges for makeup application, it is also envisioned to be used for any application where typical low-swell foams may be used. In the present disclosure, makeup refers to any material commonly used in the cosmetic industry such as powder, foundations, cream, lotion, blush, concealer, rimer, highlighter, rouge, gloss, or similar materials.

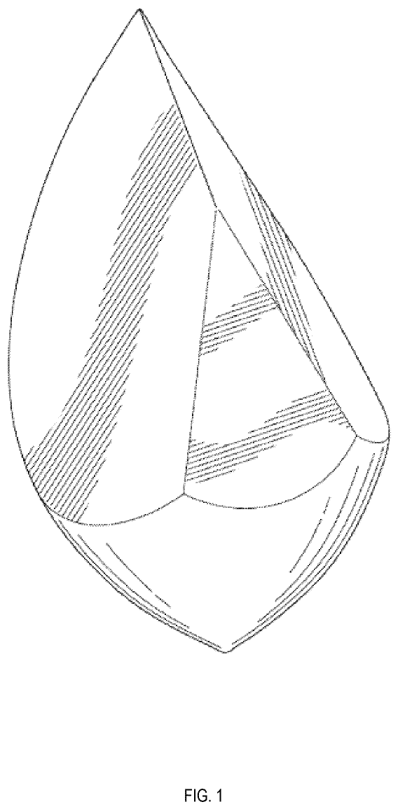

FIG. 1 shows a low-swell foam manufacture according to one embodiment of the present disclosure. In some embodiments, the foam material may be porous. In some embodiments, the manufacture may be a sponge, blender, or any type of applicator for applying makeup or other substances. As used herein, the terms “porosity,” “porous,” and “microporosity” refers to a characteristic of a material describing the inclusion of voids, channels, openings, recessed regions, etc., also referred to herein as pores or micropores, in the body of material. Some embodiments of the invention optimize the absorption qualities of the sponge, blender, or any type of applicator without leading to extensive expansion of the sponge, blender, or any type of applicator. While FIG. 1 shows one manufacture of a low-swell foam, the invention described below may be of any size, shape, or dimension.

In some embodiments a prepolymer component consisting of isocyanate monomers is combined with an aqueous component comprising water and a polyacrylonitrile fiber, and in other embodiments the isocyanate prepolymer is combined with a polyol. In some embodiments the isocyanate is a diisocyanate. Examples of diisocyanates are toluene diisocyanate (TDI) and methylene diphenyl diisocyanate (MDI). In other embodiments more than two isocyanates are found on each monomer, such as tri- or tetraisocyanate monomers. Monomers with different number of polymerization points allows for differing polymerization patterns and thus foam structures, and thus having different embodiments with these different monomers is essential for manufacturing foams whose structural diversity matches the diversity of the foam application.

As used herein, the term “polymer” refers to a molecule composed of repeating structural units, referred to herein as monomers or repeat units, connected by covalent chemical bonds. Polymers are generally characterized by a high molecular weight, such as a molecular weight greater than 100 atomic mass units (amu), greater than 500 amu, greater than 1000 amu, greater than 10000 amu or greater than 100000 amu. In some embodiments, a polymer may be characterized by a molecular weight provided in g/mol or kg/mol, such as a molecular weight of about 200 kg/mol or about 80 kg/mol. The term polymer includes homopolymers, or polymers consisting essentially of a single repeating monomer subunit. The term polymer also includes copolymers, which are formed when two or more different types of monomers are linked in the same polymer. Copolymers may comprise two or more monomer subunits, and may include random, block, alternating, segmented, grafted, tapered and other copolymers. Useful polymers include organic polymers that may be in amorphous, semi-amorphous, crystalline or partially crystalline states.

As used herein, the term “repeat unit” refers to a part of a polymer that represents a repetitive structure of the polymer chain, the repetition of which would make up the complete polymer chain with the exception of end groups corresponding to terminal ends of the polymer chain. A repeat unit may also be referred to herein as a monomer. Repeat units may be identified in a polymer structure by brackets or parentheses and include a subscript ‘n’ or ‘z’, which represents the degree of polymerization. In some embodiments, values for subscript ‘n’ or ‘z’ include integers selected from, for example, 1 to 100, 5 to 500, 10 to 500, 10 to 1000, 50 to 900, 100 to 800, or 200 to 500. It will be appreciated that a value for subscript ‘n’ or ‘z’ in a polymer may not be explicitly provided, consistent with use by skilled artisans in the field of polymer chemistry.

In some embodiments, they low-swell foam is made by combining the prepolymer component with an aqueous component. In some embodiments, the aqueous component comprises at least one filler and a polyacrylonitrile fiber. In some embodiments, the aqueous component comprises at least one filler, polyacrylonitrile fiber, at least one surfactant, at least one preservative, at least one coloring agent, additional ingredients to help control cell size, or combinations thereof. In this patent the term constituents refers to any of the different materials which are added to water to form the aqueous component.

As used herein, the term “fillers” includes generally hydrophobic compounds which are added to the foam construct. In many embodiments the fillers include powdered inorganic compounds generally insoluble in water.

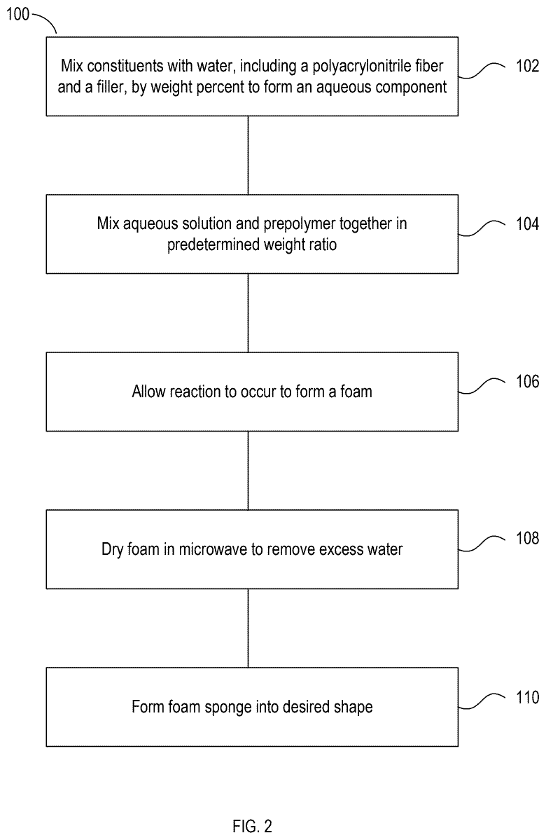

FIG. 2 displays a flowchart (100) describing the method used to make one embodiment of the invention with an aqueous component. The first step involves adding the constituents to water, including a polyacrylonitrile fiber and a filler, to form the aqueous component (102). In some embodiments these constituents are soluble in water. In many embodiments the filler, being one of the constituents, is mostly insoluble in water. The amount of material combined together to form the aqueous component is determined by weight percent for each component. Next, the prepared aqueous component and a prepolymer are mixed together using a pre-determined ratio of each component (104). The ratio of aqueous component to prepolymer is determined by weight. After the reaction is allowed to occur between the aqueous layer and the prepolymer (106) the resulting foam is dried in to remove excess water (108). Finally, the foam is formed into the desired sponge shape (110). Each of these steps are discussed in more detail below, as well as other embodiments made by alternative methods.

In some embodiments, the filler is added to increase the hydrophobicity of the foam. In some embodiments the filler is added to the aqueous component, in others the filler is added to the prepolymer, and in other embodiments the filler is added separately. In some embodiments, the filler and polyacrylonitrile fiber, added together at predefined ratios, leads to the low-swell properties. In some embodiments, the filler is Wollastonite NYAD 400. Each of these materials are discussed in more detail below, as well as other embodiments made by alternative methods.

Provided herein is a low-swell foam comprising a prepolymer component and an aqueous component comprising water and a polyacrylonitrile fiber, wherein the polyacrylonitrile fiber comprises 0.10% to 1.00% of the aqueous component by weight, and the prepolymer component and the aqueous component are mixed together, and excess water is removed, to form the low-swell foam. In terms of ranges, the polyacrylonitrile fiber comprises at least 0.10% to 0.20%, at least 0.15% to 0.25%, at least 0.20% to 0.30%, at least 0.25% to 0.35%, at least 0.30% to 0.40%, at least 0.35% to 0.45%, at least 0.40% to 0.50%, at least 0.45% to 0.55%, at least 0.50% to 0.60%, at least 0.55% to 0.65%, at least 0.60% to 0.70%, at least 0.65% to 0.75%, at least 0.70% to 0.80%, at least 0.75% to 0.85%, at least 0.80% to 0.90%, at least 0.85% to 0.95%, or at least 0.90% to 1.00% of the aqueous component by weight.

In some embodiments the prepolymer and aqueous component are mixed by weight ratios and in some embodiments by volume ratios. In some embodiments, the prepolymer component is a product of isocyanate and polyols. In some embodiments the ratio of the isocyanate to aqueous component is an approximately equal one-to-one ratio, and in some embodiments it is an unequal ratio. In some embodiments the ratio is up to about one part isocyanate to about two parts aqueous component and in other embodiments the ratio is up to about one part isocyanate to about three parts aqueous component. In some embodiments, foams made with an approximately 1:1 aqueous component to isocyanate ratio may be useful when a lower weight percentage of the constituents are needed, when the constituents have good solubility or suspension ability in water, when relative costs are not a significant concern, or when a more rapid reaction is desired. In contrast, foams made with an approximately 3:1 aqueous component to isocyanate ratio may be useful when a higher weight percentage of the constituents are needed, when the constituents have poor solubility or suspension ability in water, when relative costs are a significant concern, or when a more rapid reaction is not significant. In some embodiments, foams made with an approximately 2:1 aqueous component to isocyanate ratio are useful when an intermediate balance is desired.

The reaction between isocyanates and water is spontaneous at ambient temperature, exothermic, and results in the production of carbon dioxide which is typically used as an internal blowing agent. Depending on the consistency and structure of the foam these various parameters can be altered based on reaction conditions. In some embodiments this process is completed by stirring at ambient temperature (about 25° C.). This method uses the least amount of energy as heating or cooling is not required. In some embodiments, to slow down the reaction and ensure proper mixing of the reactants the reaction is cooled to between about 25° C. and about 0° C. Keeping the reaction above about 0° C. may be important to prevent the aqueous layer from freezing. In some embodiments the aqueous component and isocyanate are pre-cooled before mixing to ensure the reaction temperature does not significantly increase, in other embodiments only the material not being poured is cooled, and in some embodiments the reaction is cooled after the addition of the materials. In some embodiments, as a means of speeding up the reaction and forcing rapid interactions the reaction is heated above about 25° C. but below about 100° C. Keeping the reaction below about 100° C. is important as it may keep the aqueous layer from boiling and may also keep the reaction from reacting too rapidly or becoming dangerous. Similar to embodiments where the reaction is cooled the individual reactants are heated separately before the mixing in some embodiments, or after mixing in other embodiments.

As the reaction produces carbon dioxide, in some embodiments the reaction is completed under pressurized conditions to ensure that the carbon dioxide gas is contained within the foam structure when forming such that the gas acts as an internal blowing agent. In some embodiments an alternative blowing agent is added to the reaction. These alternative blowing agents comprise the gasses consisting of external carbon dioxide, oxygen, nitrogen, argon, air, or combinations thereof.

In some embodiments, after the reaction is complete, the resultant foam is dried to drive off the excess water from the aqueous component not used in the reaction. In some embodiments the drying process is completed in a microwave reactor. In some embodiments the drying process is completed in an oven, and in other embodiments the drying process is completed via drying in air. In some embodiments where the foam is dried in the microwave or oven the foam is dried under heated conditions. In some embodiments the foam is heated from about 25-50° C., in other embodiments from about 50-100° C., and in other embodiments over about 100° C. The chemical nature of the foam itself as well as the constituents in the aqueous component determines the ideal temperature for drying. When using little to no constituents in the aqueous component which need to be preserved after drying higher temperatures (about 100° C. or higher) can be used as this most efficiently drives off the water at or above its boiling point. However, some constituents are not stable at higher temperatures, thus temperatures ranging from about 25-100° C. could be used. Similarly, the stability of certain urea, carbamate, or carbonate bonds are temperature dependent and could react with water molecules at higher temperatures, destroying the stability and structure of the foam.

In some embodiments, after drying, the foam is formed into a desired shape. In some embodiments the foam reaction takes place in a vessel which confines the reaction to the desired shape such that no forming is required. For embodiments where the foam is formed, this process may be completed by the methods consisting of cutting, burning, molding, or combinations thereof.

In some embodiments, the prepolymer component and the aqueous component react together at a ratio of 0.70 to 3.00. In some embodiments, the prepolymer component and the aqueous component react together at a ratio of 1.20 to 2.00. In some embodiments, the aqueous component react together at a ratio of 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00, 3.05, 3.10, 3.15, 3.20, 3.25, 3.30, 3.35, 3.40, 3.45, or 3.50.

In some embodiments, the prepolymer component is a product of isocyanate and polyols. In some embodiments, the isocyanate is a poly-isocyanate. In some embodiments, the isocyanate comprises 0.5% to 3.5% of the low-swell foam. In some embodiments, the isocyanate comprises 0.3% to 0.5% of the low-swell foam. In some embodiments, the isocyanate comprises 0.5% to 1.0% of low-swell foam. In some embodiments, the isocyanate comprises 0.5% to 1.5% of low-swell foam. In some embodiments, the isocyanate comprises 1.0% to 2.0% of low-swell foam. In some embodiments, the isocyanate comprises 1.0% to 2.5% of low-swell foam. In some embodiments, the isocyanate comprises 1.5% to 3.0% of low-swell foam. In some embodiments, the isocyanate comprises 2.0% to 3.5% of low-swell foam. In some embodiments, the isocyanate comprises 2.5% to 4.0% of low swell foam. In some embodiments, the isocyanate comprises 3.0% to 4.0% of low-swell foam.

In some embodiments, the low-swell foam comprises at least one additive. In some embodiments, the at least one additive is an antibacterial and/or an antimicrobial. In some embodiments, the additive is a surfactant, a sealant, a binder, a self-emulsifying base, a colorant, or a salt.

In some embodiments one or more additives are added to the low-swell foam as a means of enhancing the foam in some way. As used herein, an “additive” is any chemical which is added to the foam which is not the isocyanate monomer, the water of the aqueous component, the polyol or polyamine, or the filler. In some embodiments the additive is a surfactant or other chemical which alters the formation of the internal foam structure. In some embodiments the additive is a health or beauty product which enhances use of the foam. In some embodiments the additive is a preservative. In some embodiments the additive protects the foam against bacteria or microbes. In some embodiments the additive is a surfactant. Examples of additives as defined include retinol (or vitamin Ai), hyaluronic acid, niacinamide, ceramide, peptides, curcuminoids, calcium, glycolic acid, argan oil, essential oils, cosmetic oils, perfumes, fragrances, caffeine, salicylic acid, alpha-hydroxy acid, green tea, collagen, coloring agents, almond power, Shea fragrance, antibacterials, antimicrobials, charcoal, Germaben II, silane, antifoam emulsions, defoamers, surfactants, emulsifiers, Pluronic® L62, Pluronic® F88, Eumulgin® 1000, Eumulgin® B 2, Emulgade® 1000 NI, or combinations thereof. In some embodiments, the additive is added to water to constitute the aqueous component before mixing with the prepolymer, and in other embodiments the additive is added to the reaction mixture directly.

In some embodiments the constituents only include the one or more additives and in some embodiments the constituents include both the additive and filler. In some embodiments, no filler may be useful when the benefits of the additive are the main focus, such as additives which alter the physical properties of the foam. In some embodiments, the combination of a filler and additive may be useful when a firmer less absorbent foam is desired in combination with the benefits provided by the additive. An example of this is a foam with a skin care additive in combination with a filler. The filler gives the foam less absorbency and provides more payoff of the makeup, and this added payoff of the makeup provides more payoff of the skin care additives which are solubilized from the foam by the makeup. For the purposes of this disclosure, the fillers include generally hydrophobic compounds which are added to the foam construct. In many embodiments the fillers include powdered inorganic compounds generally insoluble in water. Examples of fillers which fall under the current disclosure are calcium silicate, calcium metasilicate mineral (Wollastonite), aluminum silicate, magnesium silicate, diatomaceous earth (celite), glass spheres, silica, alumina, and combinations thereof. In some embodiments only one filler is used as a means of having a simpler foam with less need for storing and maintaining a wide variety of fillers, and in other embodiments more than one filler is used in order to give benefits from various filler materials. The different types of fillers have different benefits due to the diverse chemical composition, physical characteristics, and chemical characteristics. For instance, in some embodiments, the filler is a hollow glass sphere. In some embodiments, the density of Wollastonite is greater than hollow glass spheres, as these glass spheres contain significant amounts of air trapped within the external perimeter. Thus, foams with the same volume of Wollastonite and glass spheres would comprise significantly less weight of glass spheres versus Wollastonite.

In some embodiments the fillers used are fine powders with an average particle size under 10 microns, in other embodiments the average particle size is 10-50 microns, in other embodiments the average particle size is 50-100 microns, and in other embodiments the average particle size is over 100 microns. The different chemicals with each have different typical particle sizes and effective ness at these different sizes. For example, Nyco ASPECT® 4000 Wollastonite has an average particle size of 16 microns, whereas Celite® 545 has an average particle size of 20-100 microns. Powders under 10 microns are useful for effectively mixing throughout the foam but can have issues with containment if static electricity is present. Larger 100-micron powders have less propensity to get dispersed with static electricity but will mix and disperse within the foam less effectively.

In some embodiments the constituent includes only one additive and in some embodiments the constituents include more than one additive. The use of only one additive may be important when a single effect is desired, such as the addition of a surfactant to alter foam softness. The use of multiple additives may be essential when a combined effect or more than one effect is desired, such as the addition of a surfactant to make a softer foam as well as the addition of a fragrance or skin care product as a means of making a more versatile and healthy cosmetic foam sponge.

In some embodiments the amount of additive used is under about 1% of the aqueous component by weight, or between about 1% to about 4% of the aqueous component by weight, or between about 4% to about 10% of the aqueous component by weight, or greater than about 10% of the aqueous component by weight. In some embodiments, about 4% of the aqueous component by weight or less of each additive is used. In some embodiments, different additives require different amounts to have maximum effect, which is why each range is essential. As an example, only a small amount, such as under about 0.5% of the aqueous component by weight of an antimicrobial additive is needed to have the desired antimicrobial effect. On the other hand, typically more coloring, such as over about 5% of the aqueous component by weight is needed to give a vibrant and rich color. Additionally, the chemical constitution of the additive effects the amount of additive the foam can effectively hold while still being functional.

In some embodiments, due to the chemical nature of the additive, the additive is soluble in water. In these embodiments, the foam is wetted before use which solubilizes the additive and allows it to be released from the foam structure on the skin or other surface. In some embodiments, due to the chemical nature of the additive, the additive is insoluble in water. In these embodiments the makeup or other product applied to the foam solubilizes the additive and allows it to be released from the foam structure on the skin or other surface along with the product itself. In some embodiments the additives are released from the foam on their own, or without the need to be solubilized by water or products.

In some embodiments the additive is a skin care agent. Examples of skin care agents include retinol (or vitamin Ai), hyaluronic acid, niacinamide, ceramide, peptides, curcuminoids, calcium, glycolic acid, argan oil, essential oils, cosmetic oils, perfumes, fragrances, caffeine, salicylic acid, alpha-hydroxy acid, green tea, or combinations thereof. Having skin care agents in the foam which are released when applying products to the skin may be beneficial for skin care while applying makeup or other product. Skin care products may have a variety beauty or health effects, such as anti-wrinkle, anti-acne, moisturizing, anti-aging, UV protection, anti-oxidant, nutritional, and combinations thereof.

In some embodiments the additive is used for modifying the properties of the foam, or protect the foam from bacteria and microbials, and thus their release is inconsequential. In some embodiments the additive is still released via one of the methods described above, and in others the additive is generally constrained within the foam construct. Examples of additives used to modify the properties of the foam are antibacterials, antimicrobials, charcoal, Germaben II, silane, antifoam emulsions, defoamers, surfactants, emulsifiers, coloring agents, Pluronic® L62, Pluronic® F88, Eumulgin® 1000, Eumulgin® B 2, Emulgade® 1000 NI, or combinations thereof.

In some embodiments, the low-swell foam comprises a plurality of fillers, wherein each filler of the plurality of fillers comprises about 5% to 50% of the aqueous component by weight. In some embodiments, the low-swell foam comprises a plurality of fillers, wherein the combined weight of the plurality of fillers and the polyacrylonitrile fiber comprise 5.2% to 50% of the aqueous component by weight. In some embodiments, a filler of the plurality of fillers is calcium metasilicate mineral (wollastonite). In some embodiments, the polyacrylonitrile fiber comprises 0.20% to 0.75% of the aqueous component by weight. In some embodiments, the polyacrylonitrile fiber comprises 0.20% to 0.50% of the aqueous component by weight. In some embodiments, the calcium metasilicate material comprises 10% to 45% of the aqueous component by weight. In some embodiments, the calcium metasilicate material comprises 30% of the aqueous component by weight.

Examples of fillers which fall under the current disclosure are calcium silicate, calcium metasilicate mineral (Wollastonite), aluminum silicate, magnesium silicate, diatomaceous earth (celite), glass spheres, silica, alumina, and combinations thereof. In some embodiments only one filler is used as a means of having a simpler foam with less need for storing and maintaining a wide variety of fillers, and in other embodiments more than one filler is used in order to give benefits from various filler materials. The different types of fillers have different benefits due to the diverse chemical composition, physical characteristics, and chemical characteristics. For instance, the density of Wollastonite is greater than hollow glass spheres, as these glass spheres contain significant amounts of air trapped within the external perimeter. Thus, foams with the same volume of Wollastonite and glass spheres would comprise significantly less weight of glass spheres versus Wollastonite.

In some embodiments, the glass of glass spheres is borosilicate glass, in other embodiments the glass is soda lime glass, and in other embodiments the glass is a combination of borosilicate and soda-lime glass. In some embodiments the glass spheres are solid glass spheres and in other embodiments they are hollow glass spheres, comprising an external perimeter of glass with gas inside. In some embodiments the glass spheres have an average particle size below 25 microns, in other embodiments the glass spheres have an average particle size between 25 and 50 microns, in other embodiments between 50 and 100 microns, and in other embodiments above 100 microns. As mentioned above, the smaller spheres better disperse within the foam but have a propensity to have issues with static electricity, whereas the larger spheres have less propensity to get dispersed with static electricity, but will mix and disperse within the foam less effectively. In some embodiments the crust strength of the glass spheres is under 200 psi, in other embodiments the crush strength is 200-1000 psi, in other embodiments the crush strength is 1000-5000 psi, in other embodiments the crush strength is 5000-10,000 psi, and in other embodiments the crush strength is over 10,000 psi. The crush strength of the spheres is generally associated with the size and density of the sphere, with the larger denser spheres having a greater crush strength than the smaller hollow spheres. As makeup applicators are often squeezed during washing, having crush strength above 200 psi has been found to be important to avoid the spheres from breaking during this process. Other foam types which experience greater strain or force should have spheres with greater crush strength.

In embodiments which are made by the method described in FIG. 2, the filler is one of constituents added to water which comprises the aqueous component (102). The amount of filler added is determined by weight of the final aqueous. In embodiments which are made by the method described in FIG. 2, polyacrylonitrile fiber is one of constituents added to water which comprises the aqueous component (102). In some embodiments, the polyacrylonitrile fiber is acrylic flock. In a non-limiting example, the amount of acrylic flock added is determined by weight of the final aqueous component. In some embodiments the amount of filler and acrylic flock used in the foam is at least about 30% of the aqueous component by weigh, in other embodiments the amount of filler used is at least about 30% to about 50% of the aqueous component by weight, and in other embodiments greater than about 35% of the aqueous component by weight. Levels above about 35% of the aqueous component by weight of filler were especially successful at reducing the swell of the foam.

In some embodiments the fillers used are fine powders with an average particle size under 10 microns, or 10-50 microns, or 50-100 microns, or over 100 microns. The different chemicals with each have different typical particle sizes and effectiveness at these different sizes. For example, Nyco ASPECT® 4000 Wollastonite has an average particle size of 16 microns, whereas Celite® 545 has an average particle size of 20-100 microns. Powders under 10 microns are useful for effectively mixing throughout the foam, but can have issues with containment if static electricity is present. Larger 100 micron powders have less propensity to get dispersed with static electricity, but will mix and disperse within the foam less effectively.

In some embodiments the amount of filler added is determined by weight of the final aqueous component. In some embodiments the amount of filler used in the foam is under about 30% of the aqueous component by weight, in other embodiments the amount of filler used is about 30% to about 60% of the aqueous component by weight, and in other embodiments greater than about 60% of the aqueous component by weight. In some embodiments, the amount of filler used in the foam is between 30% and 60% of the aqueous component by weight.

In some embodiments the addition of the filler enhances the capability of the hydrophilic foam to be used as a more efficient makeup applicator. The filler allows the foam to absorb less makeup, release and apply more makeup to the skin, and still provide the desirable feel and texture of the applicator foam. In addition, the finish of the makeup on the skin is superior to conventional and current hydrophilic foam sponges.

In some embodiments, a filler of the plurality of fillers is a plurality of glass spheres. In some embodiments, the plurality of glass spheres comprises up 0.50% to 1.50% of the aqueous component by weight. In some embodiments, the plurality of glass spheres comprises 1.00% of the aqueous component by weight. In some embodiments, the plurality of glass spheres is a plurality of hollow glass spheres with a density of 0.115 g/cc to 0.135 g/cc. In some embodiments, the plurality of hollow glass spheres has a density of 1.125 g/cc. In some embodiments, the plurality of hollow glass spheres has a tensity of 0.45 to 0.50 g/cc. In some embodiments, the plurality of hollow glass spheres has a density of 0.48 g/cc.

As used herein, the term “glass spheres” may refer to borosilicate glass or soda-lime glass or a combination of borosilicate and soda-lime glass. In some embodiments the glass spheres are solid glass spheres and in other embodiments they are hollow glass spheres, comprising an external perimeter of glass with gas inside. In some embodiments the glass spheres have an average particle size below 25 microns, or between 25 and 50 microns, or between 50 and 100 microns, or above 100 microns. In some embodiments, the smaller spheres better disperse within the foam but have a propensity to have issues with static electricity, whereas the larger spheres have less propensity to get dispersed with static electricity but will mix and disperse within the foam less effectively. In some embodiments the crush strength of the glass spheres is under 200 psi, or 200-1000 psi, or 1000-5000 psi, or 5000-10,000 psi, or over 10,000 psi. The crush strength of the spheres is generally associated with the size and density of the sphere, with the larger denser spheres having a greater crush strength than the smaller hollow spheres. As makeup applicators are often squeezed during washing, having crush strength above 200 psi may be important to avoid the spheres from breaking during this process. Other foam types which experience greater strain or force should have spheres with greater crush strength.

In some embodiments the properties of the foam which are modified are cell size, in some embodiments hardness, in some embodiments density, in some embodiments absorbency, in some embodiments cleaning properties, and in some embodiments color.

In some embodiments, the foam has the ability to release a significant amount of the product which was absorbed after the product is used, such that the foam does not appear dirty or stained. Foams which are made with varying amounts of surfactants such as Pluronic® L62, Pluronic® F88, Eumulgin® 1000, Eumulgin® B 2, Emulgade® 1000 NI, or combinations thereof, have the unexpected effect of self-cleaning attributes such that they release products during rinsing significantly better than foam sponges without these additives and show significantly less discoloration or staining. Depending on the surfactant, various amounts of material may be optimal. In some embodiments, less than about 0.5% of the aqueous component by weight of these additives are used, in some embodiments about 0.5%-1.0%, in some embodiments about 1.0%-1.5%, and in some embodiments about 1.5%-2.5% may be used. In many of these self-cleaning embodiments less than or equal to about 1.5-2.5% of the aqueous component by weight of these additives may be used. However, in some embodiments about 0.3%-1.5% may be used. In some embodiments, an aqueous component may be used to emulsify the additive(s).

In some embodiments, after preparation of aqueous component (1) the aqueous component and isocyanate are mixed together. In some embodiments the aqueous component is added to the isocyanate which lowers the relative amount of water interacting with the isocyanate ensuring the isocyanate can react with other monomers after reacting with the water. In some embodiments the isocyanate is added to the aqueous component which lowers the relative amount of isocyanate and ensures significant production of carbon dioxide. In some embodiments both the aqueous component and isocyanate are poured into a third reaction vessel. In the above mentioned mixing methods, the rates of pouring may affect the foam construction as slower pouring may ensure full reaction of the materials being poured, while rapid pouring may allow a mixing of the materials and higher probabilities of inter-material reactions.

Aspects of the disclosure and the invention may be further understood by reference to the following no-limiting examples.

### EXAMPLES

Table 1 and Table 2 show data related to three different low-swell foam formulations and average expansion by percent for the low-swell composition. The amount of acrylic flock for each of the formulations listed in Table 1 is 0.75 parts by weight and the amount of filler (i.e., Wollastonite) is maintained at 35 parts by weight. However, in each of the formulations there was a variation in the aqueous and prepolymer ratio. The polyurethane prepolymer amount varied from about 83.3 parts by weight to about 50 parts by weight to yield aqueous prepolymer ratios from 1.2 to 2.0 parts by weight.

TABLE 1
Low-swell foam formulations variations.

| Low-Swell, Low- | | | | |
|---|---|---|---|---|
| Absorbent Foam | CONTROL | | | |
| Formulation | Parts by Weight | Parts by weight | Parts by weight | Parts by weight |
| DI Water | 93.263 | 59.254 | 59.254 | 59.254 |
| Emulgade N1000 | 1.437 | 2.146 | 2.146 | 2.146 |
| Acrylic Flock | 0 | 0.75 | 0.75 | 0.75 |
| Filler - | 0 | 35 | 35 | 35 |
| Wollastonite | | | | |
| NYAD 400 | | | | |
| Niax L-550 | 2 | 2 | 2 | 2 |
| Surfactant | | | | |
| Pluronic L-62 | 0.5 | 0.5 | 0.5 | 0.5 |
| Surfactant | | | | |
| Silquest A1120 | 0 | 0.15 | 0.15 | 0.15 |
| Colorant (various) | 2.7 | 0.1 | 0.1 | 0.1 |
| Salt | 0.1 | 0.1 | 0.1 | 0.1 |
| | 100 | 100 | 100 | 100 |
| Aqueous/Prepolymer | 1 | 1.2 | 1.65 | 2 |
| Ratio | | | | |
| Polyurethane | 100 | 83.3 | 60.61 | 50 |
| Prepolymer | | | | |

TABLE 2
Low-swell foam expansion by %.

| | Linear | Linear | % Weight | Volume |
|---|---|---|---|---|
| | Expansion (L) | Expansion (Dia) | Gain | Expansion (%) |
| Average Wet | 16.65 | 12.98 | 1288.49 | 54.51 |
| Fully Saturated | | | | |
| Average Wrung | 21.40 | 25.20 | 137.15 | 83.78 |

### Exemplary Embodiments

Exemplary embodiments provided in accordance with the presently disclosed subject matter include, but are not limited to, the claims and the following embodiments:

Embodiment 1: A low-swell foam comprising a prepolymer component and an aqueous component comprising water and a polyacrylonitrile fiber, wherein the polyacrylonitrile fiber comprises 0.10% to 1.00% of the aqueous component by weight, and the prepolymer component and the aqueous component are mixed together, and excess water is removed, to form the low-swell foam.

Embodiment 2: The low-swell foam of embodiment 1, wherein the prepolymer component and the aqueous component react together at a ratio of 0.70 to 3.00.

Embodiment 3: The low-swell foam of embodiment 1 or embodiment 2, wherein the prepolymer component and the aqueous component react together at a ratio of 1.20 to 2.00.

Embodiment 4: The low-swell foam of any one of embodiments 1 to 3, wherein the prepolymer component is a product of isocyanate and polyols.

Embodiment 5: The low-swell foam of any one of embodiments 1 to 4, wherein the isocyanate is a poly-isocyanate.

Embodiment 6: The low-swell foam of any one of embodiments 1 to 5, wherein the isocyanate comprises 0.5% to 3.5% of the low-swell foam.

Embodiment 7: The low-swell foam of any one of embodiments 1 to 6, wherein the polyacrylonitrile fiber is acrylic flock.

Embodiment 8: The low-swell foam of any one of embodiments 1 to 7, further comprising at least one additive.

Embodiment 9: The low-swell foam of any one of embodiment 1 to 8, wherein the at least one additive is an antibacterial and/or an antimicrobial.

Embodiment 10: The low-swell foam of any one of embodiments 1 to 9, wherein the additive is a surfactant, a sealant, a binder, a self-emulsifying base, a colorant, or a salt.

Embodiment 11: The low-swell foam of any one of embodiments 1 to 10, further comprising a plurality of fillers, wherein each filler of the plurality of fillers comprises about 5% to 50% of the aqueous component by weight.

Embodiment 12: The low-swell foam of one of embodiments 1 to 11, further comprising a plurality of fillers, wherein the combined weight of the plurality of fillers and the polyacrylonitrile fiber comprise 5.2% to 50% of the aqueous component by weight.

Embodiment 13: The low-swell foam of embodiment 11 or embodiment 12, wherein a filler of the plurality of fillers is calcium metasilicate mineral (wollastonite).

Embodiment 14: The low-swell-foam of any one of embodiments 1 to 13, wherein the polyacrylonitrile fiber comprises 0.20% to 0.75% of the aqueous component by weight.

Embodiment 15: The low-swell foam of any one of embodiments 1 to 14, wherein the polyacrylonitrile fiber comprises 0.20% to 0.50% of the aqueous component by weight.

Embodiment 16: The low-swell foam of embodiment 13, wherein the calcium metasilicate material comprises 10% to 45% of the aqueous component by weight.

Embodiment 17: The low-swell foam of embodiment 16, wherein the calcium metasilicate material comprises 30% of the aqueous component by weight.

Embodiment 18: The low-swell foam of embodiment 11 or embodiment 12, wherein a filler of the plurality of fillers is a plurality of glass spheres.

Embodiment 19: The low-swell foam of embodiment 18, wherein the plurality of glass spheres comprises up 0.50% to 1.50% of the aqueous component by weight.

Embodiment 20: The low-swell foam of embodiment 18 or embodiment 19, wherein the plurality of glass spheres comprises 1.00% of the aqueous component by weight.

Embodiment 21: The low-swell foam of any one of embodiments 18 to 20, wherein the plurality of glass spheres is a plurality of hollow glass spheres with a density of 0.115 g/cc to 0.135 g/cc.

Embodiment 22: The low-swell foam of any one of embodiments 18 to 21, wherein the plurality of hollow glass spheres has a density of 1.125 g/cc.

Embodiment 23: The low-swell foam of any one of embodiments 18 to 22, wherein the plurality of hollow glass spheres has a tensity of 0.45 to 0.50 g/cc.

Embodiment 24: The low-swell foam of embodiment 23, wherein the plurality of hollow glass spheres has a density of 0.48 g/cc.

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “1, 2, 3, 1 and 2, 1 and 3, 2 and 3, or 1, 2 and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by examples, embodiments, and optional features, modification and variation of the concepts herein disclosed may be resorted to by those skilled in the art, and that such modifications and variations are considered to be within the scope of this invention as defined by the appended claims.

What is claimed is:

1. A low-swell foam comprising:
a prepolymer component; and
an aqueous component comprising water and a polyacrylonitrile fiber;
wherein:
the polyacrylonitrile fiber comprises 0.10% to 1.00% of the aqueous component by weight, and
the prepolymer component and the aqueous component are mixed together, and excess water is removed, to form the low-swell foam.

2. The low-swell foam of claim 1, wherein the prepolymer component and the aqueous component react together at a ratio of 0.70 to 3.00.

3. The low-swell foam of claim 1, wherein the prepolymer component and the aqueous component react together at a ratio of 1.20 to 2.00.

4. The low-swell foam of claim 1, wherein the prepolymer component is a product of isocyanate and polyols.

5. The low-swell foam of claim 1, wherein the isocyanate is a poly-isocyanate.

6. The low-swell foam of claim 4, wherein the isocyanate comprises 0.5% to 3.5% of the low-swell foam.

7. The low-swell foam of claim 1, wherein the polyacrylonitrile fiber is acrylic flock.

8. The low-swell foam of claim 1, further comprising at least one additive.

9. The low-swell foam of claim 8, wherein the at least one additive is an antibacterial and/or an antimicrobial.

10. The low-swell foam of claim 8, wherein the additive is a surfactant, a sealant, a binder, a self-emulsifying base, a colorant, or a salt.

11. The low-swell foam of claim 1, further comprising a plurality of fillers, wherein each filler of the plurality of fillers comprises about 5% to 50% of the aqueous component by weight.

12. The low-swell foam of claim 1, further comprising a plurality of fillers, wherein the combined weight of the plurality of fillers and the polyacrylonitrile fiber comprise 5.2% to 50% of the aqueous component by weight.

13. The low-swell foam of claim 11, wherein a filler of the plurality of fillers is calcium metasilicate mineral (wollastonite).

14. The low-swell-foam of claim 1, wherein the polyacrylonitrile fiber comprises 0.20% to 0.75% of the aqueous component by weight.

15. The low-swell foam of claim 1, wherein the polyacrylonitrile fiber comprises 0.20% to 0.50% of the aqueous component by weight.

16. The low-swell foam of claim 13, wherein the calcium metasilicate material comprises 10% to 45% of the aqueous component by weight.

17. The low-swell foam of claim 16, wherein the calcium metasilicate material comprises 30% of the aqueous component by weight.

18. The low-swell foam of claim 11, wherein a filler of the plurality of fillers is a plurality of glass spheres.

19. The low-swell foam of claim 18, wherein the plurality of glass spheres comprises up 0.50% to 1.50% of the aqueous component by weight.

20. The low-swell foam of claim 19, wherein the plurality of glass spheres comprises 1.00% of the aqueous component by weight.

21. The low-swell foam of claim 18, wherein the plurality of glass spheres is a plurality of hollow glass spheres with a density of 0.115 g/cc to 0.135 g/cc.

22. The low-swell foam of claim 21, wherein the plurality of hollow glass spheres has a density of 1.125 g/cc.

23. The low-swell foam of claim 18, wherein the plurality of hollow glass spheres has a tensity of 0.45 to 0.50 g/cc.

24. The low-swell foam of claim 23, wherein the plurality of hollow glass spheres has a density of 0.48 g/cc.
